(19) United States
(12) Patent Application Publication
(10) Pub. No.: US 2026/0238125 A1
(43) Pub. Date: Aug. 13, 2026

(54) CHARGE PUMP WITH NON-DISSIPATIVE VOLTAGE SENSING

(71) Applicant: Renesas Electronics America Inc., Milpitas, CA (US)

(72) Inventor: Eric Magne SOLIE, Durham, NC (US)

(73) Assignee: Renesas Electronics America Inc., Milpitas, CA (US)

(21) Appl. No.: 19/052,621

(22) Filed: Feb. 13, 2025

(51) Int. Cl. H02M 3/07; H02M 1/00

(52) U.S. Cl. CPC H02M 3/077; H02M 1/0025; H02M 1/0035

(57) ABSTRACT

Systems and methods for implementing charge pump power conversion with non-dissipative voltage sensing is described. The device can include a charge pump configured to convert an input voltage into an output voltage. The charge pump can comprise a first phase and a second phase. The device can further include a circuit configured to receive an activation signal. The circuit can, in response to receipt of the activation signal, sample a node voltage being outputted by the second phase. The circuit can output a signal that can indicate whether the output voltage can be within a reference voltage from a steady state voltage of the load or outside of the reference voltage from the steady state voltage of the load.

### BACKGROUND

The present disclosure relates in general to semiconductor devices. More specifically, the present disclosure relates to a charge pump with non-dissipating output voltage sensing.

A charge pump power converter is a type of DC-DC converter that can convert an input voltage to a desired output voltage without using inductors. Instead, it relies on capacitors as energy storage elements and switches to control the charge transfer process. The charge pump typically includes a controller, switches, and capacitors. The controller provides control signals (such as clock signals) to the switches, which alternately connect capacitors in series or parallel configurations. This alternate switching enables the capacitors to transfer and store charge, effectively boosting or inverting the input voltage to produce the desired output voltage.

### SUMMARY

In one embodiment, a semiconductor device that can implement charge pump power conversion with non-dissipative voltage sensing is generally described. The semiconductor device can include a charge pump configured to convert an input voltage into an output voltage. The charge pump can comprise a first phase and a second phase. The semiconductor device can further include a circuit configured to receive an activation signal. The circuit can be configured to, in response to receipt of the activation signal, sample a node voltage being outputted by the second phase. The circuit can be further configured to output a signal that can indicate whether the output voltage can be within a reference voltage from a steady state voltage of the load or outside of the reference voltage from the steady state voltage of the load.

In one embodiment, a semiconductor device that implement charge pump power conversion with non-dissipative voltage sensing is generally described. The semiconductor device can include a charge pump configured to convert an input voltage into an output voltage. The charge pump can comprise a first phase and a second phase. The semiconductor device can further include a circuit configured to sample a node voltage being outputted by the second phase. The circuit can be further configured to, based on the node voltage, determine whether the output voltage can be within a reference voltage from a steady state voltage of the load or outside of the reference voltage from the steady state voltage of the load. The semiconductor device can also include a controller configured to receive a request to sample the output voltage. The controller can be further configured to, in response to receipt of the request, activate the circuit to sample the node voltage. The controller can be further configured to determine whether the output voltage can be within a reference voltage from a steady state voltage of the load or outside of the reference voltage from the steady state voltage of the load.

In one embodiment, a method that implement charge pump power conversion with non-dissipative voltage sensing is generally described. The method can include operating a charge pump circuit in a normal mode to convert an input voltage into an output voltage. The charge pump can comprise a first phase and a second phase. The method can further include receiving a request to sample the output voltage. The method can also include, in response to receiving the request, operating the charge pump circuit in a sampling mode to sample a node voltage being outputted by the second phase. The method can further include, based on the node voltage, determining whether the output voltage can be within a reference voltage from a steady state voltage of the load or outside of the reference voltage from the steady state voltage of the load.

### BRIEF DESCRIPTION OF THE DRAWINGS

FIG. 1 is a diagram showing a system that can implement charge pump power conversion with non-dissipative voltage in one embodiment.

FIG. 2 is a diagram showing an example implementation of charge pump power conversion with non-dissipative voltage in another embodiment.

FIG. 3 is another diagram showing waveforms generated by a charge pump with non-dissipative voltage sensing in an example embodiment.

FIG. 4 is another diagram showing waveforms generated by a charge pump with non-dissipative voltage sensing in an example embodiment.

FIG. 5 is a flow chart illustrating a process to implement a charge pump with non-dissipative voltage sensing in an example embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

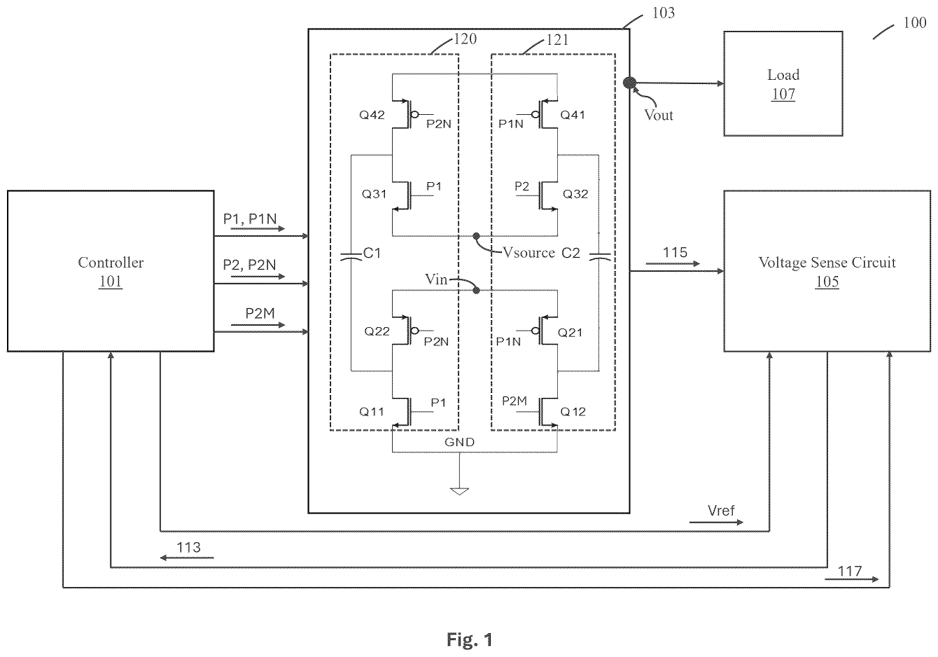

FIG. 1 is a diagram showing a system that can implement a charge pump with non-dissipative voltage sensing in one embodiment. A system 100 shown in FIG. 1 can be implemented by one or more semiconductor devices. System 100 can include at least a controller 101, a charge pump power converter circuit 103 (hereinafter “charge pump 103”), a voltage sense circuit 105, and a load 107.

Controller 101 can be, for example, a processor, microcontroller, central processing unit (CPU), field-programmable gate array (FPGA), a state machine, or any other circuitry that is configured to control and operate system 100. While described as a state machine in illustrative embodiments, controller 101 is not limited to a state machine in these embodiments and may comprise any other circuitry that is configured to control and operate charge pump 103 and/or voltage sense circuit 105. Controller 101 can be configured to generate control signals, such as pulse width modulation (PWM) or pulse frequency modulation (PFM) signals for controlling charge pump 103 and receive feedback information signals 113 from voltage sense circuit 105. Controller 101 can comprise of a clock to synchronize the PWM signals cycle by cycle.

Charge pump 103 can be, for example, a two-phase charge pump comprising of two phases 120, 121, or two converters in a full-bridge circuit configuration connected in parallel and two capacitors C1, C2 connected in between. Controller 101 can be configured to control the two phases 120, 121 in a coordinated sequence. Each full-bridge converter, representing one phase, can comprise of four switching elements such that charge pump 103 can comprise of a total of eight switching elements Q11, Q12, Q21, Q22, Q31, Q31, Q41, Q42 (hereinafter “switches Q”). Switches Q can be, for example, field-effect transistors (FETs) such as metal oxide semiconductor field effect transistors (MOSFETs). Charge pump 103 can be configured to switch the switches Q ON and OFF to convert an input voltage Vin into a voltage to be output at voltage output pin Vout (or output voltage Vout) to load 107. Load 107 can be, for example but not limited to, a capacitive load such as an n-channel metal oxide semiconductor (NMOS) transistor such that the output voltage at Vout can be a gate voltage for driving the NMOS transistor. The output voltage Vout can be a gate voltage for driving load 107.

Controller 101 can be configured to provide PWM control signals P1, P2, and P2M to the corresponding phases of the charge pump 103. Controller 101 can generate PWM control signals P1 that are 180 degrees out of phase from the PWM control signals P2 generated for phases 120, 121. Control signals P2M can be the same as control signals P2 during normal operations of charge pump 103. To be described in more detail below, during a modified operation, i.e. sampling mode, control signals P2M can be different from control signals P2. Switches Q11 and Q31 can be configured to receive control signals P1 and switch Q32 can be configured to receive control signals P2. Switches Q22 and Q42 can be configured to receive control signals P2N, where control signals P2N is an inverted version of control signals P2. Switches Q21 and Q41 can be configured to receive control signals P1N, where control signals P1N is an inverted version of control signals P1. Switch Q12 can be configured to receive modified control signals P2M.

In another example embodiment, switch Q12 can be configured to receive control signals P2 and switch Q21 can be configured to receive the modified control signal. The modified control signal can be a modified version of control signal P1N. The control signals P to be input into each switch Q can vary depending on how the switches are turned ON and OFF by the controller 101.

In addition, there can be a “break before make” function, where there is a transition period configured to have all switches Q be in the OFF state for a brief period of time prior to transitioning to their configured state. For example, during this “break before make” time, the switches Q transition to an OFF state. After a set specified time of being OFF, then half of the switches Q remain OFF and half of the switches Q turn ON.

During normal operations, controller 101 can be configured to control the switches Q of charge pump 103 in a default switching sequence. When control signals P1 and P2N is high/ON (or high voltage representing logic value 1), control signals P2 and P1N would be low/OFF (or low voltage representing logic value 0). Thus, switches Q11, Q21, Q31, and Q41 would be ON and switches Q12, Q22, Q32 and Q42 would be OFF. When the corresponding switches are ON, capacitor C1 begins charging and storing voltage and capacitor C2 begins delivering voltage to the load 107. When control signals P1 and P2N are low/OFF and control signals P2 and P1N are high/ON, switches Q11, Q21, Q31, and Q41 would be OFF and switches Q12, Q22, Q32 and Q42 would be ON. When these corresponding switches are ON, capacitor C2 begins charging and storing voltage and capacitor C1 begins delivering voltage to the load 107.

Voltage sense circuit 105 can be, for example, a circuit configured to be in communication with the charge pump 103. Voltage sense circuit 105 can comprise of various electrical components configured to monitor the output voltage of the charge pump. Voltage sense circuit 105 can also be configured to provide feedback information signals 113 to controller 101 based on the monitored output voltage. In one embodiment, controller 101 can receive a request, e.g., by a user of system 100, to determine or measure Vout. In response to receiving the request, controller 101 can be configured to operate in a sampling mode operation. Controller 101 can be configured to generate a SELECT signal 117 to operate voltage sense circuit 105 to sample a voltage Vx on sample cap C3 and voltage 115. Voltage 115 can be, for example, a voltage being generated by the second phase 121 in charge pump 103. To be described in more detail below, the voltage 115 being sensed by voltage sense circuit 105 can be used for determining Vout with minimal dissipation of power.

In an aspect, charge pump 103 can be operated at a relatively high oscillation frequency to increase the output current to increase the output voltage Vout at a relatively higher rate to reach steady state voltage of the load 107. However, higher oscillation frequency of the charge pump 103 can cause the charge pump 103 to consume more power. To minimize the amount of power consumed, it may be desirable to reduce the oscillation frequency as soon as the steady state voltage of the load 107 is reached. However, conventional voltage sensing circuits uses a sense resistor for sensing Vout, where the sensed Vout can be scaled and compared to a reference voltage Vref to determine whether the steady state voltage of the load 107 has been reached. The sense resistor can increase power dissipation which leads to increased quiescent current. In addition, the time to reach the steady state voltage of the load 107 can be delayed because the sense resistor acts as an additional load that draws current from the output. The dissipation and delay caused by the sense resistor can result in an inefficient system requiring more power and time.

To address the dissipation and delay issues in conventional systems that uses sense resistors, controller 101 can be configured to operate in the sampling mode that can be different from the normal operations. To enter sampling mode, controller 101 can generate SELECT signal 117 that can be in-phase with the ON time of control signals P2. At the same cycle C that the SELECT signal 117 is generated, controller 101 can control modified control signals P2M to maintain an OFF state until the next cycle C+1, while control signals P2 is turned ON. The utilization of the control signals P2M to maintain an OFF state for a cycle can allow the output voltage Vout to reach the steady state voltage at a relatively higher rate, reducing the delay for the charge pump 103 to transition to a lower operating frequency, and remain in the lower frequency state for a longer time. The delay reduction in operation frequency of the charge pump 103 allows for the reduction in the over-all charge pump bias current, thus minimizing the power dissipation.

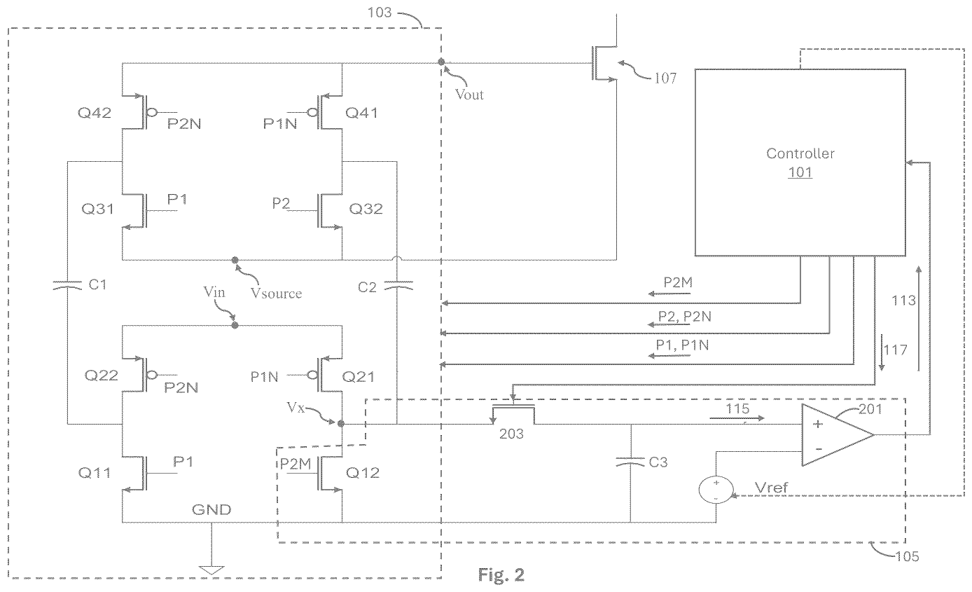

FIG. 2 is a diagram showing an implementation of a charge pump with non-dissipative voltage sensing in another embodiment. Descriptions of FIG. 2 may reference components shown in FIG. 1. In the example embodiment shown in FIG. 2, voltage sense circuit 105 can comprise of a comparator 201, a FET 203, and a capacitor C3. When controller 101 sends SELECT signal 117 to turn ON FET 203 under the sampling mode, voltage sense circuit 105 can sample the voltage at node Vx between switches Q21 and Q12. When FET 203 is turned on, switch Q12 of charge pump 103 is off and can be switched into voltage sense circuit 105 to facilitate sensing or sampling of the voltage at node Vx. Further, when FET 203 is turned on, sensed voltage 115 is the output voltage at node Vx and can be input into the non-inverting input of comparator 201. Reference voltage Vref can be input into the inverting input of comparator 201. Comparator 201 can compare the reference voltage Vref to the voltage at node Vx. An output of comparator 201 can be provided to controller 101 as feedback information signals 113. Capacitor C3 can be connected between voltage 115 and ground to store the voltage.

During normal operations, FET 203 is turned off and voltage sense circuit 105 is inactive. During the sampling mode, with control signal P1N can be modified to turn ON when SELECT signal 117 is ON as well and control signal P1N is OFF, the output voltage at the node Vx can be provided to comparator 201 since FET 203 is turned ON by SELECT signal 117. The voltage at node Vx can be compared with a reference voltage Vref relative to the power supply voltage.

In another example embodiment, during normal operations, FET 203 is turned off and voltage sense circuit 105 is inactive. Control signal P1N at switch Q21 can be a modified signal and switch Q12 can receive control signal P2. During the sampling mode, the output voltage at the node Vx, which is equal to Vin−(Vout−Vsource), can be provided to comparator 201 since FET 203 is turned ON by SELECT signal 117. The sampled voltage Vx can be stored on the capacitor C3. The stored voltage in capacitor C3 can then be provided to comparator 201 and comparator 201 can compare Vx with Vref to determine if the output voltage Vout has reached the steady state voltage. For example, the steady state voltage level on Vin can be 5 v, Vsource can be 10 v, and the reference voltage is 0.2 V. Comparator 201 can compare the voltage at node Vx to determine if the output voltage Vout is within a range of 0.2 V (e.g., +/−0.2V) from the steady state voltage level of 15.0V. If the Vout is within a range of the reference voltage from the steady state voltage level, then the feedback information signals 113 being outputted by comparator 201 can indicate that Vout has reached the steady state voltage (e.g., binary ‘1’ or logic high). If the Vout is outside of the range of the reference voltage from steady state voltage level, then the feedback information signals 113 being outputted by comparator 201 can indicate that Vout has yet to reach the steady state voltage (e.g., binary ‘0’ or logic low). Instead of conventionally using a sense resistor to sense the output voltage Vout directly, the sensed voltage at node Vx can be used to determine the output voltage Vout, without requiring implementation of a sense resistor. Therefore, sampling Vx and using the output from comparator 201 to determine whether Vx is within the reference voltage from the steady state voltage can allow controller 101 to determine whether Vout has reached steady state voltage without a sense resistor.

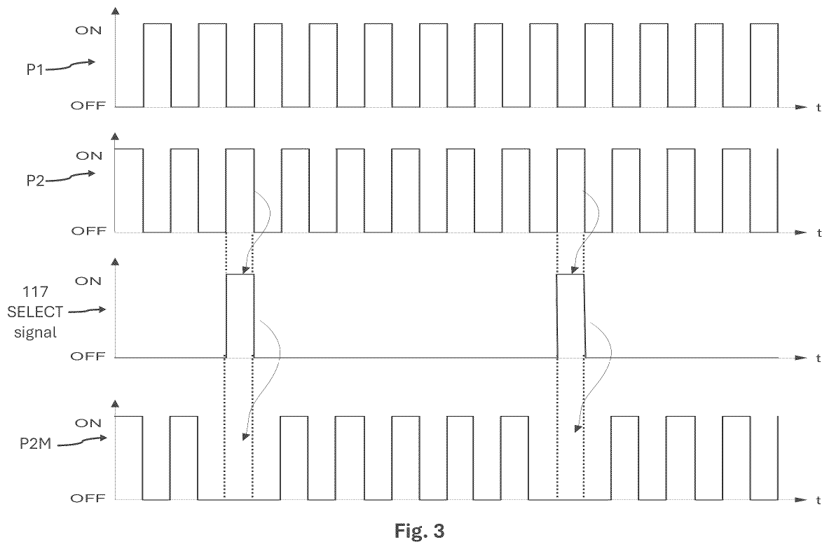

FIG. 3 is a diagram showing the waveforms generated by a charge pump with non-dissipative voltage sensing in an example embodiment. Descriptions of FIG. 3 may reference components shown in FIG. 1 and FIG. 2. In the example embodiment shown in FIG. 3, the waveforms of control signals P1, P2, P2M and SELECT signal 117 generated by a system, such as system 100, are illustrated. As seen in the diagram, control signal P1 switches 180 degrees out of phase with control signal P2. At start time, system 100 can operate under normal operation mode using a default switching sequence wherein, control signal P2 is ON, and control signals P1 is OFF. In one cycle, control signal P2 is then turned OFF and control signals P1 is turned ON. The ON and OFF state of control signals P1, P2 alternate continuously. Further, under normal operation mode control signal P2M mirrors the control signals P2. When control signals P2 turns ON, control signals P2M is ON as well and visa versa.

In one embodiment, in a predetermined amount of cycles, SELECT signal 117 can switch from a continuous OFF state to an ON state for a single cycle. In other words, the SELECT signal 117 can be in the ON state periodically such that Vx can be sampled periodically under the sampling mode. The periodic sampling mode can be implemented by having controller 101 rising the SELECT signal 117 to the ON state, for example, every 1024 clock cycles to activate voltage sense circuit 105 periodically. The ON time for SELECT signal 117 is synchronized to be the same as the ON time of control signal P2. Accordingly, during the same cycle that SELECT signal 117 is ON, controller signal P2M maintains an OFF state rather than mirroring control signal P2 and turning ON. When SELECT signal 117 returns back to an OFF state, controller signals P1, P2, and P2M return to the default switching sequence as previously described. Control signals P1, P2 and P2M can maintain the default switching sequence for the predetermined amount of cycles before SELECT signal 117 turns back ON for a single cycle again.

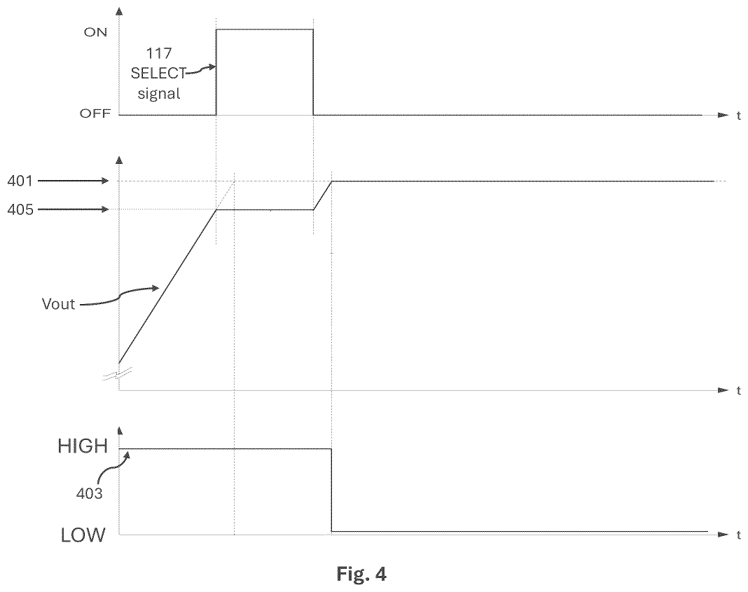

FIG. 4 is another diagram showing waveforms generated by a charge pump with non-dissipative voltage sensing in an example embodiment. Descriptions of FIG. 4 may reference components shown in FIG. 1-FIG. 3. In the example embodiment shown in FIG. 4, the waveforms for SELECT signals 117, output voltage Vout, and switching frequency waveform 403 are illustrated. Voltage regulation level 401 represents the predetermined regulation voltage level that charge pump 103 is configured to regulate at during normal operations. Prior to SELECT signal 117 turning ON, under normal operation mode, charge pump 103 is operating at high switching frequency as depicted by waveform 403. By operating at a high switching frequency, charge pump 103 can increase the output voltage in attempts to reach the voltage regulation level 401.

In an aspect, in conventional systems with a dissipative load, output voltage Vout would continue to decrease while operating in a voltage/current sensing mode. When returning to normal operations in a conventional system, output voltage Vout can increase until it reaches the regulation voltage level. However, the charge pump in a conventional system operates at a higher switching frequency consistently until the output voltage Vout reaches the regulation voltage level. Further, because the output voltage decreases during sensing mode, the voltage regulator system would take longer to regulate the voltage.

In the example embodiment shown in FIG. 4, when the SELECT signal 117 is ON and the voltage sensing circuit 105 is active under the sampling operation mode, control signal P2M is left in the OFF state. Therefore, energy is not transferred to the load where voltage can dissipate. Instead, while SELECT signal 117 is ON, by sampling the output voltage at the node Vx instead of a resistor, the output voltage Vout can remain regulated at a voltage level 405 lower than the voltage regulation level 401 during normal conditions. Therefore, to reach the voltage regulation level 401, charge pump 103 requires less time at high switching frequency after the SELECT signal 117 is OFF because the output voltage is already at a higher voltage level than a conventional system when returning to normal operations.

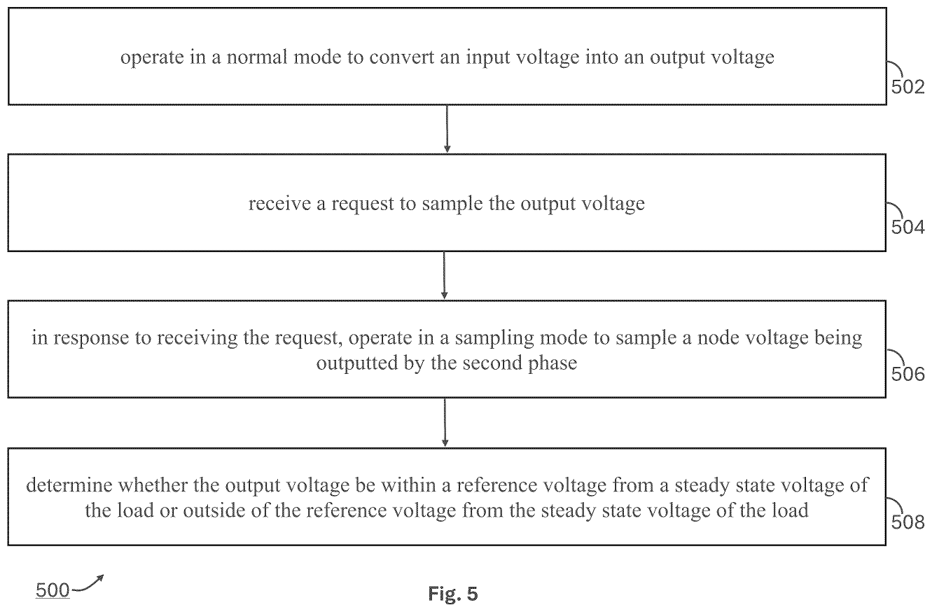

FIG. 5 is a flow chart illustrating a process to implement a charge pump with non-dissipative voltage sensing in an example embodiment. A process 500 can include one or more operations, actions, or functions as illustrated by one or more of blocks 501, 503, and/or 505. Although illustrated as discrete blocks, various blocks can be divided into additional blocks, combined into fewer blocks, eliminated, performed in different order, or performed in parallel, depending on the desired implementation.

Process 500 can be performed by a charge pump circuit. Process 500 can begin at block 502, where the charge pump circuit can operate in a normal mode to convert an input voltage into an output voltage. The charge pump can comprise a first phase and a second phase. The process 500 can continue from block 502 to block 504. At block 504, the charge pump circuit can receive a request to sample the output voltage. The process 500 can continue from block 504 to block 506. At block 506, in response to receiving the request, the charge pump circuit can operate in a sampling mode to sample a node voltage being outputted by the second phase. The process 500 can continue from block 506 to block 508. At block 508, based on the node voltage, the charge pump circuit can determine whether the output voltage be within a reference voltage from a steady state voltage of the load or outside of the reference voltage from the steady state voltage of the load.

In another embodiment, operating the charge pump circuit in a sampling mode can comprise activating a switching element connected to an output of the second phase. In another embodiment, operating the charge pump in the sampling mode can further comprise comparing the node voltage with the reference voltage to determine whether the output voltage be within the reference voltage from a steady state voltage of the load or outside of the reference voltage from the steady state voltage of the load.

In another embodiment, the charge pump circuit can further operate in a normal operation mode by using a first pulse width modulation signal and a second pulse width modulation signal to control the first phase. The second pulse width modulation signal can be 180 degrees out of phase from the first pulse width modulation signal. The charge pump circuit can also use the first pulse width modulation signal and the second pulse width modulation signal to control the second phase.

In another embodiment, the charge pump circuit can further use a first pulse width modulation signal and a second pulse width modulation signal, the second pulse width modulation signal can be 180 degrees out of phase from the first pulse width modulation signal to control the first phase. The charge pump circuit can also use the first pulse width modulation signal and a third pulse width modulation signal being different from the second pulse width modulation signal to control the second phase. In another embodiment, operating the charge pump in the sampling mode can further comprise maintaining the third pulse width modulation signal in an OFF state.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### EXAMPLES

Example 1: A semiconductor device comprising: a charge pump configured to convert an input voltage into an output voltage, wherein the charge pump comprises a first phase and a second phase; and a circuit configured to: receive an activation signal; in response to receipt of the activation signal, sample a node voltage being outputted by the second phase; and output a signal that indicates whether the output voltage is within a reference voltage from a steady state voltage of the load or outside of the reference voltage from the steady state voltage of the load.
Example 2: The semiconductor device of example 1, wherein the circuit comprises a switching element connected to an output of the second phase, the circuit is configured to sample the node voltage when the switching element is activated.
Example 3: The semiconductor device of any one of examples 1 to 2, wherein the circuit is configured to: compare the node voltage with the reference voltage to determine whether the output voltage is within the reference voltage from a steady state voltage of the load or outside of the reference voltage from the steady state voltage of the load.
Example 4: The semiconductor device of any one of examples 1 to 3, wherein under a normal operation mode: the first phase receives a first pulse width modulation signal and a second pulse width modulation signal, wherein the second pulse width modulation signal is 180 degrees out of phase from the first pulse width modulation signal; and the second phase receives the first pulse width modulation signal and the second pulse width modulation.
Example 5: The semiconductor device of any one of examples 1 to 4, wherein under a sampling operation mode: the first phase receives a first pulse width modulation signal and a second pulse width modulation signal, wherein the second pulse width modulation signal is 180 degrees out of phase from the first pulse width modulation signal; and the second phase receives the first pulse width modulation signal and a third pulse width modulation signal different from the second pulse width modulation signal.
Example 6: The semiconductor device of any one of examples 1 to 5, wherein: when the activation signal is in an ON state, the third pulse width modulation signal is in an OFF state.
Example 7: The semiconductor device of any one of examples 1 to 6, wherein the circuit is further configured to: receive the activation signal periodically; and sample the node voltage periodically.
Example 8: A semiconductor device comprising: a charge pump configured to convert an input voltage into an output voltage, wherein the charge pump comprises a first phase and a second phase; a circuit configured to: sample a node voltage being outputted by the second phase; and based on the node voltage, determine whether the output voltage is within a reference voltage from a steady state voltage of the load or outside of the reference voltage from the steady state voltage of the load; and a controller configured to: receive a request to sample the output voltage; in response to receipt of the request, activate the circuit to sample the node voltage; and determine whether the output voltage is within a reference voltage from a steady state voltage of the load or outside of the reference voltage from the steady state voltage of the load.
Example 9: The semiconductor device of example 8, wherein the circuit comprises a switching element connected to an output of the second phase, the controller is configured to activate the switching element to activate the circuit.
Example 10: The semiconductor device of any one of examples 8 to 9, wherein the controller is configured to: compare the node voltage with the reference voltage to determine whether the output voltage is within the reference voltage from the steady state voltage of the load or outside of the reference voltage from the steady state voltage of the load.
Example 11: The semiconductor device of any one of examples 8 to 10, wherein the controller is further configured to: use a first pulse width modulation signal and a second pulse width modulation signal to control the first phase and second phase when the circuit is deactivated, wherein the second pulse width modulation signal is 180 degrees out of phase from the first pulse width modulation signal.
Example 12: The semiconductor device of any one of examples 8 to 11, wherein when the circuit is activated, the controller is further configured to: use a first pulse width modulation signal and a second pulse width modulation signal to control the first phase; and use the first pulse width modulation signal and a third pulse width modulation signal different from the second pulse width modulation signal to control the second phase.
Example 13: The semiconductor device of any one of examples 8 to 12, wherein: when the circuit is activated, the third pulse width modulation signal is in an OFF state.
Example 14: The semiconductor of any one of examples 8 to 13, wherein the controller is further configured to: activate the circuit periodically to sample the node voltage periodically.
Example 15: A method comprising: operating a charge pump circuit in a normal mode to convert an input voltage into an output voltage, wherein the charge pump comprises a first phase and a second phase; receiving a request to sample the output voltage; in response to receiving the request, operating the charge pump circuit in a sampling mode to sample a node voltage being outputted by the second phase; and based on the node voltage, determining whether the output voltage is within a reference voltage from a steady state voltage of the load or outside of the reference voltage from the steady state voltage of the load.
Example 16: The method of any one of example 15, wherein, operating the charge pump circuit in a sampling mode comprises activating a switching element connected to an output of the second phase.
Example 17: The method of any one of examples 15 to 16, wherein operating the charge pump in the sampling mode further comprises: comparing the node voltage with the reference voltage to determine whether the output voltage is within the reference voltage from a steady state voltage of the load or outside of the reference voltage from the steady state voltage of the load.
Example 18: The method of any one of examples 15 to 17, further comprising operating the charge pump circuit in a normal operation mode by: using a first pulse width modulation signal and a second pulse width modulation signal to control the first phase, wherein the second pulse width modulation signal is 180 degrees out of phase from the first pulse width modulation signal; and using the first pulse width modulation signal and the second pulse width modulation signal to control the second phase.
Example 19: The method of any one of examples 15 to 18 further comprising: using a first pulse width modulation signal and a second pulse width modulation signal, wherein the second pulse width modulation signal is 180 degrees out of phase from the first pulse width modulation signal to control the first phase; and using the first pulse width modulation signal and a third pulse width modulation signal being different from the second pulse width modulation signal to control the second phase.
Example 20: The method of any one of examples 15 to 19, wherein operating the charge pump in the sampling mode further comprises maintaining the third pulse width modulation signal is in an OFF state.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A semiconductor device comprising:
a charge pump configured to convert an input voltage into an output voltage, wherein the charge pump comprises a first phase and a second phase; and
a circuit configured to:
receive an activation signal;
in response to receipt of the activation signal, sample a node voltage being outputted by the second phase; and
output a signal that indicates whether the output voltage is within a reference voltage from a steady state voltage of a load or outside of the reference voltage from the steady state voltage of the load.

2. The semiconductor device of claim 1, wherein the circuit comprises a switching element connected to an output of the second phase, the circuit is configured to sample the node voltage when the switching element is activated.

3. The semiconductor device of claim 1, wherein the circuit is configured to:
compare the node voltage with the reference voltage to determine whether the output voltage is within the reference voltage from a steady state voltage of the load or outside of the reference voltage from the steady state voltage of the load.

4. The semiconductor device of claim 1, wherein under a normal operation mode:
the first phase receives a first pulse width modulation signal and a second pulse width modulation signal, wherein the second pulse width modulation signal is 180 degrees out of phase from the first pulse width modulation signal; and
the second phase receives the first pulse width modulation signal and the second pulse width modulation.

5. The semiconductor device of claim 1, wherein under a sampling operation mode:
the first phase receives a first pulse width modulation signal and a second pulse width modulation signal, wherein the second pulse width modulation signal is 180 degrees out of phase from the first pulse width modulation signal; and
the second phase receives the first pulse width modulation signal and a third pulse width modulation signal different from the second pulse width modulation signal.

6. The semiconductor device of claim 5, wherein, when the activation signal is in an ON state, the third pulse width modulation signal is in an OFF state.

7. The semiconductor device of claim 1, wherein the circuit is further configured to:
receive the activation signal periodically; and
sample the node voltage periodically.

8. A semiconductor device comprising:
a charge pump configured to convert an input voltage into an output voltage, wherein the charge pump comprises a first phase and a second phase;
a circuit configured to:
sample a node voltage being outputted by the second phase; and
based on the node voltage, determine whether the output voltage is within a reference voltage from a steady state voltage of a load or outside of the reference voltage from the steady state voltage of the load; and
a controller configured to:
receive a request to sample the output voltage;
in response to receipt of the request, activate the circuit to sample the node voltage; and
determine whether the output voltage is within a reference voltage from a steady state voltage of the load or outside of the reference voltage from the steady state voltage of the load.

9. The semiconductor device of claim 8, wherein the circuit comprises a switching element connected to an output of the second phase, the controller is configured to activate the switching element to activate the circuit.

10. The semiconductor device of claim 8, wherein the controller is configured to:
compare the node voltage with the reference voltage to determine whether the output voltage is within the reference voltage from the steady state voltage of the load or outside of the reference voltage from the steady state voltage of the load.

11. The semiconductor device of claim 8, wherein the controller is further configured to:
use a first pulse width modulation signal and a second pulse width modulation signal to control the first phase and second phase when the circuit is deactivated, wherein the second pulse width modulation signal is 180 degrees out of phase from the first pulse width modulation signal.

12. The semiconductor device of claim 8, wherein when the circuit is activated, the controller is further configured to:
use a first pulse width modulation signal and a second pulse width modulation signal to control the first phase; and
use the first pulse width modulation signal and a third pulse width modulation signal different from the second pulse width modulation signal to control the second phase.

13. The semiconductor device of claim 12, wherein, when the circuit is activated, the third pulse width modulation signal is in an OFF state.

14. The semiconductor of claim 8, wherein the controller is further configured to:
activate the circuit periodically to sample the node voltage periodically.

15. A method comprising:
operating a charge pump circuit in a normal mode to convert an input voltage into an output voltage, wherein the charge pump comprises a first phase and a second phase;
receiving a request to sample the output voltage;
in response to receiving the request, operating the charge pump circuit in a sampling mode to sample a node voltage being outputted by the second phase; and
based on the node voltage, determining whether the output voltage is within a reference voltage from a steady state voltage of a load or outside of the reference voltage from the steady state voltage of the load.

16. The method of claim 15, wherein operating the charge pump circuit in a sampling mode comprises activating a switching element. connected to an output of the second phase.

17. The method of claim 15, wherein operating the charge pump in the sampling mode further comprises:
comparing the node voltage with the reference voltage to determine whether the output voltage is within the reference voltage from a steady state voltage of the load or outside of the reference voltage from the steady state voltage of the load.

18. The method of claim 15, further comprising operating the charge pump circuit in a normal operation mode by:
using a first pulse width modulation signal and a second pulse width modulation signal to control the first phase, wherein the second pulse width modulation signal is 180 degrees out of phase from the first pulse width modulation signal; and
using the first pulse width modulation signal and the second pulse width modulation signal to control the second phase.

19. The method of claim 15 further comprising:
using a first pulse width modulation signal and a second pulse width modulation signal, wherein the second pulse width modulation signal is 180 degrees out of phase from the first pulse width modulation signal to control the first phase; and
using the first pulse width modulation signal and a third pulse width modulation signal being different from the second pulse width modulation signal to control the second phase.

20. The method of claim 19, wherein operating the charge pump in the sampling mode further comprises maintaining the third pulse width modulation signal is in an OFF state.
